(19) United States
(12) Patent Application Publication
(10) Pub. No.: US 2004/0017757 A1
(43) Pub. Date: Jan. 29, 2004

(54) Method of editing and reproducing compression audio data

(76) Inventors: Tetsuhiko Kaneaki, Hyogo (JP); Tomoaki Izumi, Osaka (JP); Keiichi Kameda, Kyoto (JP); Akira Sobajima, Osaka (JP); Masahiko Hatanaka, Osaka (JP); Kiminori Matsuno, Osaka (JP); Shuji Morita, Osaka (JP)

Correspondence Address: RATNERPRESTIA, P O BOX 980, VALLEY FORGE, PA, 19482-0980, US

(21) Appl. No.: 10/381,639

(22) PCT Filed: Oct. 1, 2001
(86) PCT No.: PCT/JP01/08628

(30) Foreign Application Priority Data
Sep. 29, 2000 (JP) 2000-300071
Oct. 10, 2000 (JP) 2000-308765
Oct. 10, 2000 (JP) 2000-308767

(51) Int. Cl. H04N 5/76; G11B 27/02; G11B 27/00

(52) U.S. Cl. 369/83; 360/13; 386/52

(57) ABSTRACT

For audio data configured in units of frames with a header at the top and compressed in a way such that data corresponding to a specific frame is also present in a different frame, the present invention executes at least one of the following processing (1) and processing (2) at dividing this compressed audio into two pieces of audio data, i.e., front and rear pieces, at a predetermined position. (1) A step to divide the audio data into front and rear pieces, and a step to add data of a predetermined number of bytes at the beginning of the rear audio data to an end of the front audio data. (2) A step to divide the audio data into front and rear pieces, and a step to add data of a predetermined number bytes from an end of the front audio data to the front of the beginning of the rear audio data. This prevents the generation of abnormal noise even when data is compressed in a way, typically in MP3, such that location of a frame and location of data for that frame do not always match. The present invention also enables seamless reproducing when two pieces of audio data, formed by dividing previously one piece of data, are reproduced consecutively.

### TECHNICAL FIELD

The present invention relates to compressed audio data editing and reproducing methods applicable to apparatuses for editing and reproducing compressed audio signals in which data for a specific frame also exists outside of that frame, in particular MPEG1-LAYER 3 and MPEG2-LAYER 3 (hereafter referred to as MP3).

### BACKGROUND ART

A conventional method of editing compressed audio data is described next. For example, in the method used for mini disks (MDs), data is divided immediately before a header of each frame to create independent pieces of audio data for editing. During reproducing, each piece of audio data is simply read out consecutively. This is the editing and reproducing method for MDs.

However, when the above method is applied to editing and reproducing audio data, such as in MP3 format, in which a part of data corresponding to a top frame of edited audio data is also recorded in a frame before this top frame, the following disadvantage occurs.

In the case of MP3 data, to consecutively reproduce first audio data and then second audio data (when data is simply divided as in the case of the above MD), data corresponding to a top frame of the second audio data needs to be present at the end of the first audio data. However, since the operator of the reproducing apparatus can freely designate which frames are the first and second audio data, data corresponding to the top frame of the second audio data does not always exist at the end of the first audio data. In this case, data for the top frame of the second audio data becomes different from what it was previously. More specifically, reproducing of partially missing compressed data causes abnormal noise.

### DISCLOSURE OF INVENTION

To counteract the above disadvantage, the present invention offers a method of editing and reproducing compressed audio data without generating abnormal noise when pieces of audio data are consecutively reproduced.

The present invention solves the disadvantage in the next way. In a method of editing audio data configured in units of frames with a header at the top and compressed in a way such that data corresponding to a specific frame is also present in a different frame, the present invention executes at least one of processing (1) and processing (2), described below, at dividing the compressed audio data into two pieces of audio data, i.e., front and rear pieces, at a predetermined position.

(1) A step for dividing the audio data into front and rear pieces, and a step for adding data of a predetermined number of bytes at the beginning of the rear audio data to the end of the front audio data.

(2) A step for dividing the audio data into the front and rear pieces, and a step to add data of a predetermined number bytes from the end of the front audio data to the front of the beginning of the rear audio data.

This makes it possible to determine the continuity of two pieces of audio data by using the end part of the front audio data and the top part of the rear audio data. Accordingly, abnormal noise can be appropriately prevented.

Another embodiment of the present invention solves the disadvantage in the next way. For audio data configured in units of frames with a header at the top and compressed in a way such that data corresponding to a specific frame is also present in a different frame, the present invention includes a memory for storing this audio data and a flag related to the audio data; a demodulator for demodulating audio signals based on the audio data and the flag; and an editor for dividing and connecting the audio data and setting and resetting the flag based on the state of divided audio data.

The flag makes it possible to confirm how the audio data is divided and connected. Accordingly, the generation of abnormal noise when reproduce any pieces of audio data consecutively is preventable.

Still another embodiment of the present invention for solving the disadvantage edits audio data in a way such that the last cluster of the compressed front audio data and the top cluster of the compressed rear audio data are duplicated when compressed audio data in which data for the header is present before the frame header is divided into units of frames. Then, at least the following processing (1) or (2) is implemented for determining whether to reproduce the top part of the compressed audio data to be reproduced second.

(1) Predetermined top data in the last cluster of the compressed audio data to be reproduced first and predetermined top data in the top cluster of the compressed audio data to be reproduced second are compared.

(2) Data volume from the beginning to a data end of the last cluster of the compressed audio data to be reproduced first and data volume from the beginning to a data end of the top cluster of the compressed audio data to be reproduced second are compared.

This enables the continuous reproducing of two divided pieces of compressed audio data without generating abnormal noise.

### BRIEF DESCRIPTION OF THE DRAWINGS

FIG. 1 illustrates an audio data editing and reproducing method in accordance with a first exemplary embodiment of the present invention.

FIG. 2 illustrates a format of data compressed by MP3.

FIG. 3 illustrates another audio data editing and reproducing method in accordance with the first exemplary embodiment of the present invention.

FIG. 4 illustrates still another audio data editing and reproducing method in accordance with the first exemplary embodiment of the present invention.

FIG. 5 illustrates still another audio data editing and reproducing method in accordance with the first exemplary embodiment of the present invention.

FIG. 6 is a flow chart illustrating an operation of the audio editing and reproducing method in accordance with the first exemplary embodiment of the present invention.

FIG. 7 is a flow chart illustrating an operation of the audio editing and reproducing method in accordance with the first exemplary embodiment of the present invention.

FIG. 8 is a block diagram illustrating the configuration of an apparatus for implementing an audio data editing and reproducing method in accordance with a second exemplary embodiment of the present invention.

FIG. 9 illustrates audio data and a state of flag in accordance with the second exemplary embodiment of the present invention.

FIG. 10 illustrates an operation of editor in accordance with the second exemplary embodiment of the present invention.

FIG. 11 is a schematic diagram illustrating determination of the continuity/discontinuity in accordance with a third exemplary embodiment of the present invention.

FIG. 12 is a block diagram illustrating the configuration of an apparatus used for reproducing edited data in accordance with the third and a fourth exemplary embodiments of the present invention.

FIG. 13 is a schematic diagram illustrating determination of the continuity/discontinuity in accordance with the fourth exemplary embodiment of the present invention.

### DETAILED DESCRIPTION OF PREFERRED EMBODIMENTS

Exemplary embodiments of the present invention are described below with reference to drawings.

First Exemplary Embodiment

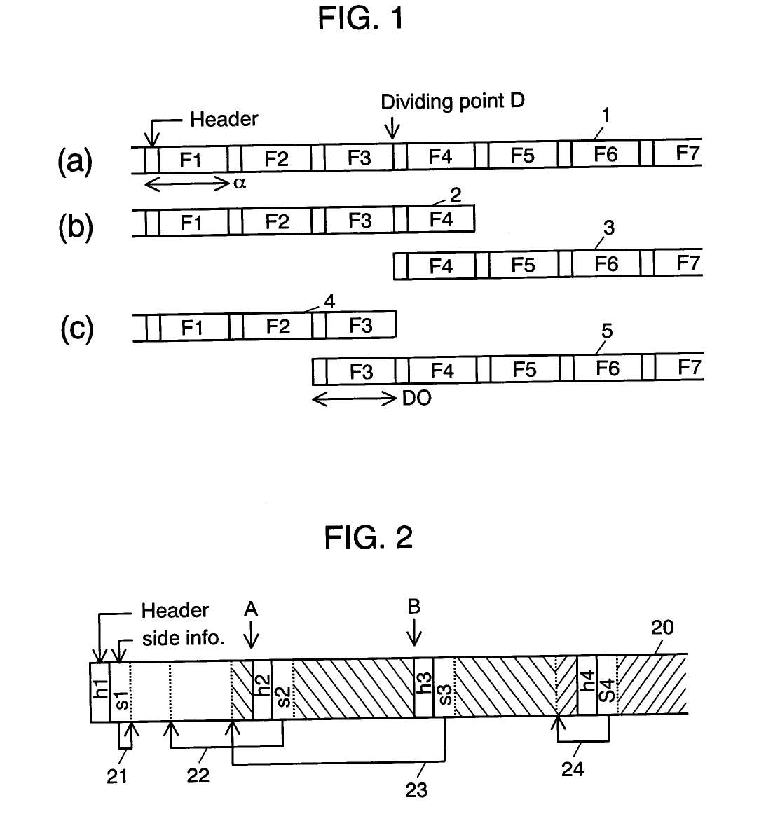

FIG. 1 is a schematic diagram for illustrating a compressed audio data editing and reproducing method in a first exemplary embodiment. FIG. 1(a) shows stream 1 of compressed audio data stream 1 in which one frame is a section indicated by α. The Figure shows an example where frame F1 and frame F2 to frame 7 are present. FIGS. 1(b) and 1(c) show a front audio data, i.e., audio data 2 and audio data 4; and rear audio data, i.e., audio data 3 and audio data 5, when audio data 1 in FIG. 1(a) is divided at dividing point D indicated by an arrow.

To simplify the description, audio data in a compressed format such as MP3, which is configured in units of frames with a header at the top and data for one frame also exists in a different frame, is used as an example. FIG. 2 shows the structure of audio data 20 compressed as MP3. From the header to immediately before the next header form one frame, and four frames are indicated in the Figure. Each frame includes header h followed by side information s. A value stored here indicates location and volume of data needed for this frame. For example, if the side information is “0,” data starts immediate after the side information, as shown by arrow 21. If the side information is “1,” data starts from 1 byte immediately before header h. At the top frame of the audio data, in general, data for that frame starts next to side information s1 (arrow 21). In other words, value “0” is written in the side information. If there is a small volume of data in the frame, data for a frame next to this fame is storable. The top position of the next frame is indicated by side information s2 (arrow 22).

In the example shown in FIG. 2, data for the first frame starts from the position indicated by arrow 21, data for the second frame starts from the position indicated by arrow 22, data for the third frame starts from the position indicated by arrow 23, and data for the fourth frame starts from the position indicated by arrow 24.

In the first exemplary embodiment, if data is divided between frame F3 and frame F4 in FIG. 1(b), audio data 2, which is front audio data, is reproduced up to frame 3. Frame 4 is not practically needed for reproducing. However, giving consideration to the case of reproducing audio data 3, which is the rear audio data, consecutively after audio data 2, frame F4 is attached at the end of audio data 2. When audio data 3 is reproduced following audio data 2, the last frame of audio data 2 and the first frame of audio data 3 are compared. If these frames match, these pieces of audio data are determined to be formed by dividing one original piece of audio data. A series of these processes is made feasible by using a microprocessor and a memory such as RAM. More specifically, frame F4 is copied to a different area in the memory, and then frames on and after frame F5 are moved after frame F4.

With respect to a specific method for dividing data, the following steps are applied to a file of audio data in the case of dividing the data between frame F3 and frame F4, as shown in FIG. 6: (1) Change the number of frames and file size; (2) Copy frame F4 to an empty area, and designate frame F4 as the top of a stream of rear audio data; and (3) Link frames on and after frame F4.

If pieces of audio data to be reproduced consecutively are formed by dividing previously one piece of audio data, they are reproduced correctly by reproducing consecutively in the order of frame F1, frame F2, frame F3, frame F4, and so on.

If front audio data 2 in FIG. 1(b) is not formed by dividing previously one piece of audio data, frame F4 of audio data 2, which is the last frame, and frame F4 of audio data 3, which is the first frame, are different. Since whether these frames match is checked in advance, the side information of frame F4, the top frame, is checked before reproducing rear audio data 3. If the side information points to its own frame (frame F4 in this case), this frame is reproduced. If not, i.e., the side information points to a previous frame such as by arrow 22 in FIG. 2, this frame is not reproduced. Instead, reproducing starts from a frame whose side information points to one of frames from the top (frame F4 in this case) and onward of this audio data. This prevents the generation of abnormal noise.

The above series of processes are executed by a digital signal processor (DSP). More specifically, as the first step, the DSP compares frame F4 of audio data 2 and frame F4 of audio data 3. If “unmatched,” the DSP checks the side information in frame F4 of audio data 3 in the next step. If the side information points to its own frame (frame F4 in this case), the DSP proceeds to a step to reproduce this frame. If not, i.e., the side information points to a previous frame, as shown by arrow 22 in FIG. 2, the frame is not reproduced, and the DSP proceeds to a step to check the side information in the next frame. This step is looped until the side information indicating one of frames from the top (frame F4 in this case) onward is found, and the DSP then proceeds to the step to reproduce the frame.

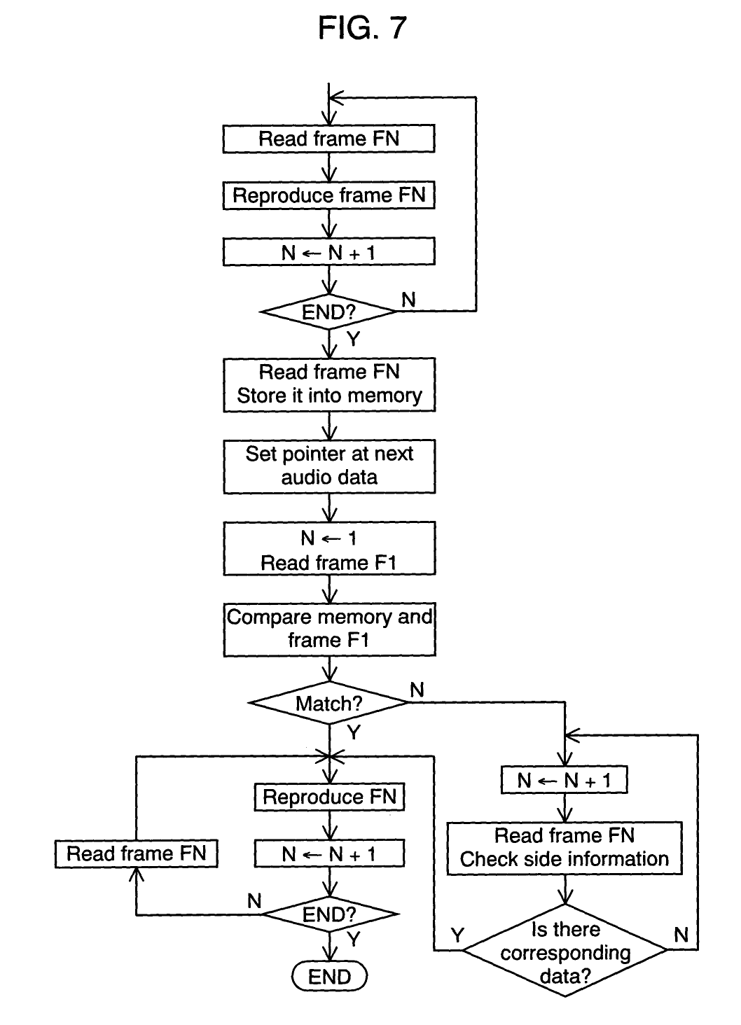

The above specific reproducing steps are shown in FIG. 7. First, one frame, FN, is read and reproduced, and then the frame is updated to the next frame (adding 1 to the frame number), and whether it is the end of the file or not is determined. If the file continues, the reproducing processing is repeated. The processing proceeds to the next step when the file completes.

The last frame is read and stored in the memory. A pointer is set to the next audio data, and N is set to 1 for reading the top frame of this data. Frame FN stored in the memory and the top frame are compared, and it is determined whether they match.

If the frames match, this frame is reproduced, and reproduced again until the last frame. If the frames do not match, the frame is incremented by 1, its side information is checked, and the presence of corresponding data is determined. If there is no corresponding data, the step for incrementing the frame is repeated. If the corresponding data is present, the step for matching is implemented.

In the first exemplary embodiment, the first single frame of audio data 3 is added to audio data 2. It is apparent that two or more frames or one frame plus several bytes can also be added as long as there is data for comparison.

In FIG. 1(c), audio data 5, which is the rear audio data, is reproduced from frame F4 so that frame F3 is not needed for reproducing, when the data is divided between frame F3 and frame F4. However, frame F3 is connected to the front of frame F4, giving consideration to the case that audio data 4, which is the front audio data, is reproduced before audio data 5. This allows the last frame of audio data 4 to be compared with the first frame of audio data 5 when audio data 4 is reproduced before audio data 5. If they match, these pieces of audio data are determined to be formed by dividing previously one piece of audio data. In this case, frame F3 in audio data 5 indicated by arrow DO is invalid data, and this frame F3 needs to be offset to prevent it from being reproduced. Naturally, for reproducing audio data 2 independently in FIG. 1(b), data up to frame F3 is reproduced, but not frame F4.

As described above, when more than one piece of audio data to be reproduced consecutively is formed by dividing previously one piece of audio data, these pieces of data are correctly reproduced in order of frame F1, frame F2, frame F3, frame F4, and so on.

If front audio data 4 in FIG. 1(c) is not formed by dividing previously one piece of audio data, frame F3 of audio data 4, which is the last frame, and frame 3 of audio data 5, which is the first frame, are different. In this case, since whether these frames match is checked in advance, the side information of frame F4, which is the first frame, is checked before reproducing rear audio data 5. If the side information in frame F4 points to a frame in its own audio data 5, this frame is reproduced. If not, i.e., when the side information points to a frame such as that indicated by arrow 23 when the dividing point is between frame F2 and frame F3 in FIG. 2, this frame is not reproduced. The data is reproduced from a frame which has side information indicating audio data 5. This prevents the generation of abnormal noise.

In FIG. 1, only one frame is added to front audio data 2 or rear audio data 5. However, plural frames can be added. Still more, data does not need to be added in units of frames. In the first exemplary embodiment, the last single frame of audio data 4 is added to audio data 5. It is apparent that two frames from the last or the last single frame plus several bytes immediately before that can also be added as long as there is data for comparison.

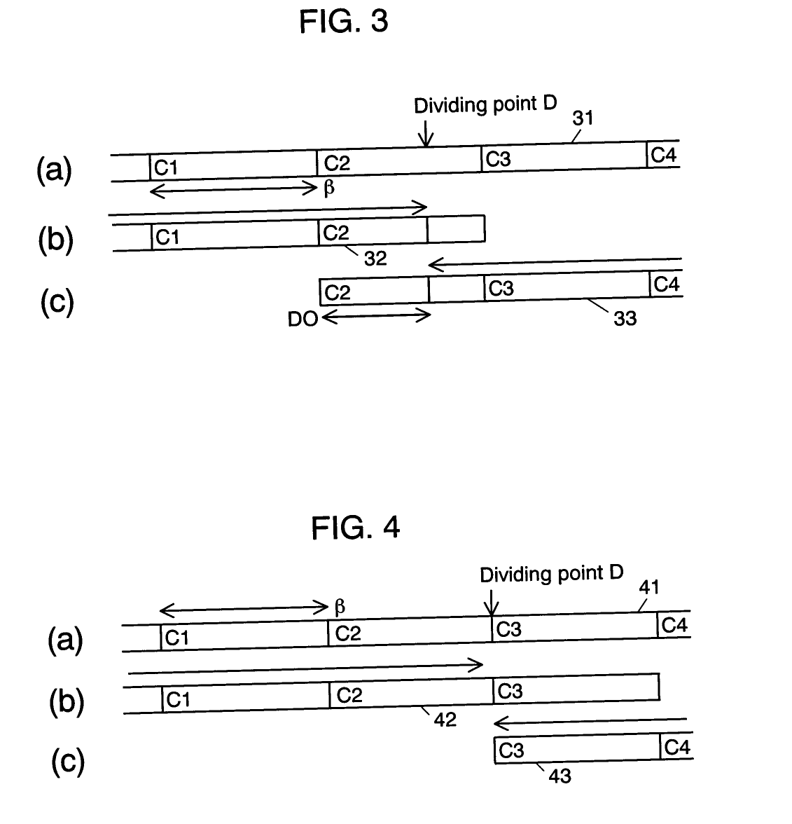

FIG. 3 shows the case when audio data is recorded in a recording medium using a cluster as the writing/reading unit. For example, floppy disks also use clusters for reading/writing. More than one frame of compressed audio data signals is stored in each cluster. In this case, FIG. 3(a) shows the processing that takes place when the data is divided at dividing point D.

FIG. 3(b) shows the case when the dividing point does not match the cluster boundary. Also in this case, the dividing point is set immediately in front of the header of a certain frame. In the Figure, a section indicated by β is one cluster.

When audio data 31 is divided, last cluster C2 of audio data 32, which becomes the front audio data, is copied to make first cluster C2 of audio data 33 which becomes the rear audio data. In other words, the same data is present in physically different places. A dividing boundary is set to exist in this cluster. This is indicated by DO in audio data 33 in FIG. 3(c). In the same manner as in FIG. 1(c), data indicated by DO in audio data 33 in FIG. 3(c), i.e., data from the top of the cluster to the dividing point, is set as data offset (invalid data), and not reproduced.

Naturally, it is acceptable to copy first cluster C2 of rear audio data 33, and use it as last cluster C2 of front audio data 32.

The use of this method enables the proper reproducing of audio data, even if the first or last cluster is deleted. In addition, for reproducing audio data 33 successively after audio data 32, the last cluster of audio data 32 and the first cluster of audio data 33 are compared. When the clusters match, these pieces of data are determined to be obtained by dividing previously one piece of audio data and reproducing is made successively from the first frame of audio data 33.

On the other hand, if the clusters are “unmatched” in the above comparison, or for reproducing only rear audio data 33, the generation of abnormal noise is suppressed by not reproducing the data, or frame, when data needed for audio data 33 exists in a cluster before the top cluster of this audio data, i.e., when the cluster boundary is Point A and the dividing point is Point B in FIG. 2.

FIG. 4 shows the case when the dividing point of audio data 41 in FIG. 4(a) matches the cluster boundary. The first one cluster of rear audio data 43 in FIG. 4(c) is added to the end of front audio data 42 shown in FIG. 4(b). This makes it possible to determine whether pieces of data are formed by dividing previously one piece of audio data by comparing last cluster C3 of audio data 42 and first cluster C3 of audio data 43.

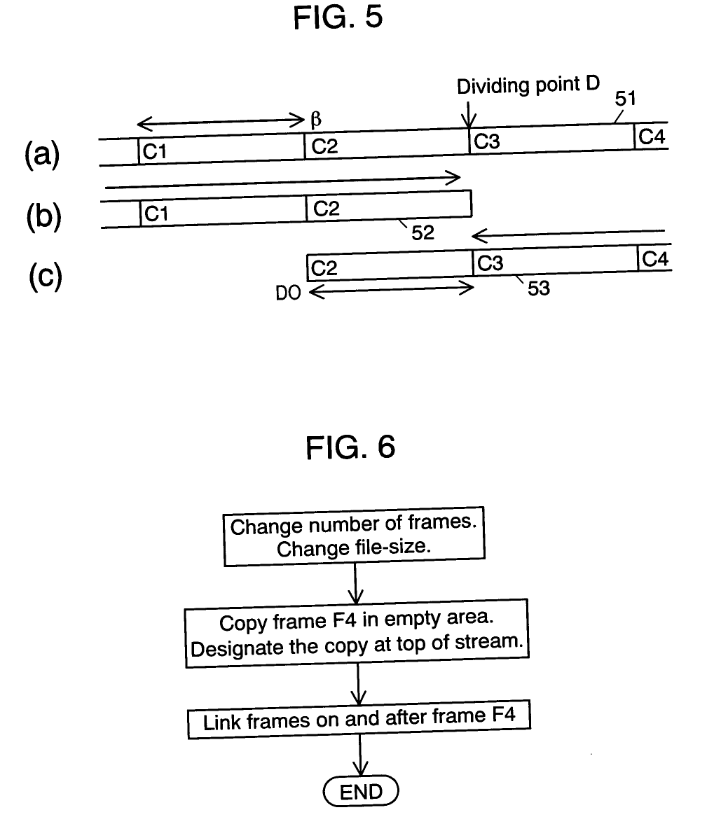

FIG. 5 shows the case where one cluster (cluster C2) immediately before the dividing point of front audio data 52 is added to the front of the top part of rear audio data 53 as data offset. This makes it possible to achieve the same effects as shown in FIG. 4. In addition, data for the top frame always exists when audio data 53 is reproduced independently, thereby enabling reproducing from the top frame.

The method shown in FIG. 5, that is to add one cluster at the top of rear audio data 53, and the method of adding one cluster to front audio data 42, as shown in FIG. 4, can be applied simultaneously.

If the dividing point of audio data and the cluster boundary match, as shown in FIGS. 4 and 5, division at this point can be ignored, and shifted to the front or back for one frame. Since one frame lasts only several tens of milliseconds, shifting the dividing point generally causes no problem.

As described above, the present invention prevents the generation of abnormal noise even when compressed data in which the frame and the location of data used in that frame do not always match, such as with MP3 data. The present invention also enables seamless reproducing when two pieces of audio data, formed by dividing previously one piece of data, are reproduced consecutively.

Second Exemplary Embodiment

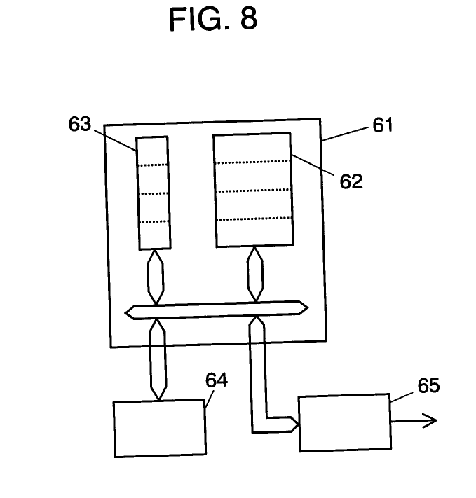

FIG. 8 is a block diagram illustrating the configuration of an apparatus used for implementing a compressed audio data editing and reproducing method in accordance with a second exemplary embodiment of the present invention. In the Figure, memory 61 stores plural pieces of audio data 62 and flags 63 corresponding to each piece of audio data 62. These are rewritable by editor 64. Demodulator 65 reads out audio data 62 and flag 63 corresponding to each audio data, and decodes audio data 62 based on flag 63.

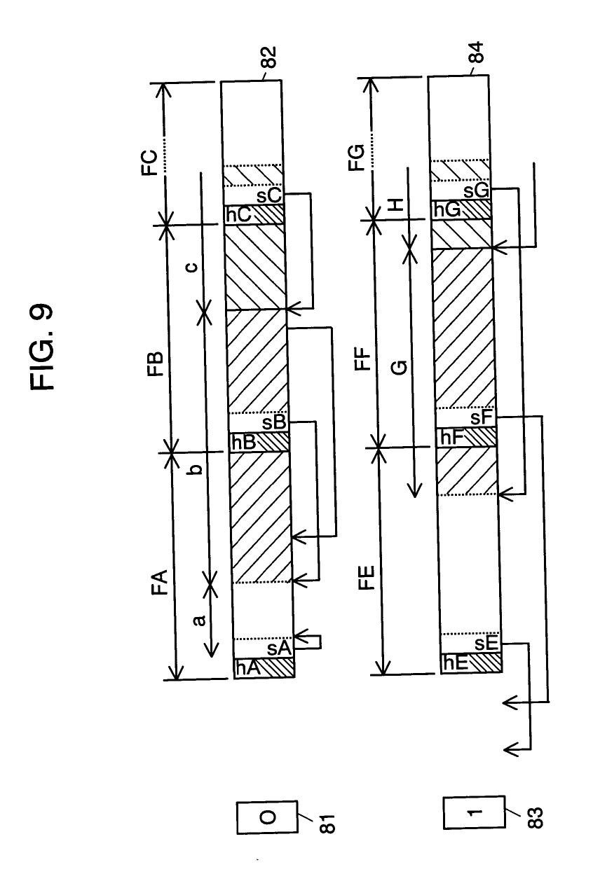

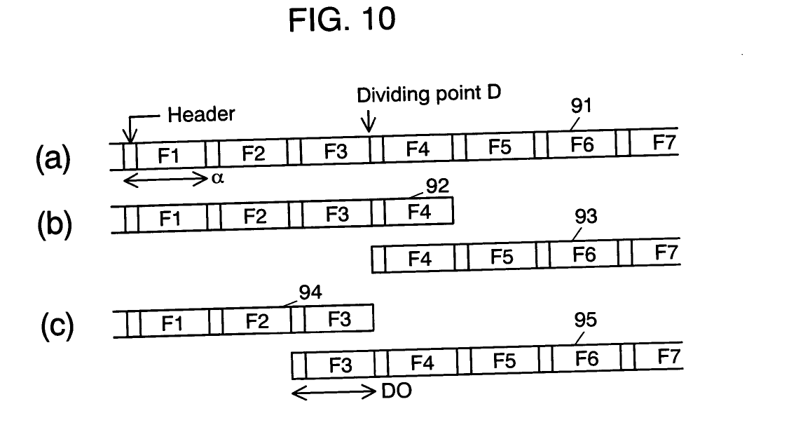

FIG. 9 illustrates the state of audio data and flag in the second exemplary embodiment of the present invention. As described in the first exemplary embodiment, using FIG. 2, side information follows the header in each frame of MP3 audio data. A value stored in the side information indicates location and volume of data needed for this frame. If the side information is “0,” data starts immediately after the side information, as shown by arrow 21 in FIG. 2. If the side information is “1”, for example, data starts from 1 byte immediately before header h. Accordingly, the value in the side information indicates, using the number of bytes, that the starting point of audio data corresponding to that frame is how many bytes before the header of the frame.

In this exemplary embodiment flags 81 and 83 are stored as flag 63, as shown in FIG. 9, and audio data 82 and 84 are stored as audio data 62, as shown in FIG. 9, in memory 61. In other words, in audio data 82, sections indicated by FA, FB, and so on indicate frames, and a hatched portion is the header. In audio data 82, side information sA in first frame FA points to the data following side information sA. Accordingly, editor 64 reads the value of side information sA in frame FA, and resets flag 81 to 0 because the value of side information sA is “0.” In audio data 84, sections indicated by FE, FF, and so on are frames, and a hatched portion is the header. In audio data 84, side information sE in first frame FE points to a frame before frame FE. Accordingly, editor 64 reads the value of side information sE in frame FE, and sets “1” to flag 83 because the value of side information sE is not “0.”

Demodulator 65 reads audio data and a flag related to that audio data from memory 61, and decodes audio data based on the state of flag, i. e., set (=1) or reset (=0). More specifically, if the flag is not set, as in the case of flag 81 in FIG. 9, data for all frames exist within that audio data. Demodulator 65 thus decodes audio data 82 from top frame FA. If the flag is set, as is the case of flag 83 in FIG. 9, at least a part or all of data corresponding to top frame FE does not exist in the first frame of this audio data. Frame FE is thus not decoded, and checking continues from frame FF to determine whether to decode or not. More specifically, demodulator 65 checks whether the value of the side information in frame FF points within audio data 84. In this case, the side information in frame FF indicates that data for frame FF exists in a frame before frame FE, and thus demodulator 65 also does not decode frame FF. Then, the next frame is checked for demodulation. More specifically, whether the value of side information sG in next frame FG points within audio data 84 is checked. In this case, side information sG in this third frame FG points to frame FE. Demodulator 65 thus determines that data for third frame FG exists in audio data 84, and decodes frame FG.

As described above, when flag 63 is set, the value of side information in each frame is checked sequentially to determine whether data for that frame exists within that audio data, and demodulation starts from the frame that data is judged to “exist.” Accordingly, decoded frame always include data required for that frame, allowing to suppress the generation of abnormal noise at the boundary of different pieces of audio data.

FIG. 10 illustrates the operation of editor 64 when audio data 91 shown in FIG. 10(a) is divided at dividing point D. If audio data 91 is divided at dividing point D, data up to frame F3 is reproduced in audio data 92, which is audio data before dividing point D, and frame 4 is not practically needed for reproducing. However, giving consideration to the case of reproducing audio data 93, which is the rear audio data, consecutively after audio data 2, as shown in FIG. 10(b), frame F4 is attached at the end of audio data 92. When audio data 93 is reproduced following audio data 92, demodulator 65 compares the last frame of audio data 92 and the first frame of audio data 93. If these frames match, these pieces of audio data are determined to be formed by dividing previously one piece of audio data, and on and after frame F4 is decoded after demodulating frame F3.

FIG. 10(c) shows the case that editor 64 adds frame F3 to audio data 95, which is the rear audio data, as data offset which is invalid data. As described above, demodulator 65 compares the last frame of audio data 94 and the first frame of audio data 95 when audio data 94, which is the front audio data, is reproduced before audio data 95 so as to determine whether these pieces of audio data are formed by dividing one original piece of audio data.

Editor 64 always sets a flag corresponding to divided pieces of audio data when the data is divided as described above. This allows demodulator 65 to check the flag for implementing a series of processes including no demodulation of several frames at the top of audio data when this flag is set.

The audio data described above can be data recorded in a recording medium sing a cluster as the writing/reading unit. For example, floppy disks also use lusters for reading/writing.

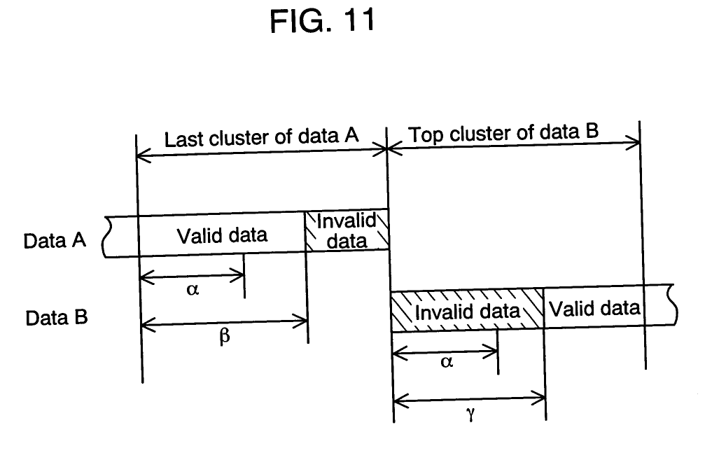

In this exemplary embodiment, demodulator 65 decodes also from the top frame of the second audio data to be decoded when the flag is reset, and checks the continuity of a frame of second audio data to be decoded and the last frame of the audio data decoded first when the flag is set, so as to determine from which frame to decode. Practically, however, since a reproducing sequence is already determined when audio data is divided by editor 64 and then reproduced, this reproducing sequence can be used. More specifically, editor 64 executes the next processing when the demodulation sequence of audio data is determined. In this case, each piece of audio data includes data for checking the continuity between the last frame of audio data already decoded and the top frame of audio data to be decoded next, as shown in FIG. 11.

If audio data B is to be decoded following audio data A, editor 64 compares the top frame of audio data B and the last frame of audio data A. If they do not match, a flag related to audio data B is set. If they match, the flag is reset. Moreover, even if they do not match, the flag related to audio data B is reset when data indicated by the side information in the top frame of audio data B exists within audio data B. This process is implemented for each piece of audio data before their demodulation starts.

This enables the omission of a step of comparison by allowing demodulator 65 to check set and reset of the flag. For example, if the flag is reset, demodulator 65 determines that this audio data can be decoded from the top frame. If the flag is set, demodulator 65 determines to decode only frames having corresponding data within the audio data.

Naturally, audio data A which is decoded first may be formed by dividing a certain audio data, as shown by audio data 93 in FIG. 10. The top frame of audio data A is thus also checked, and the flag can be set if the side information in the top frame does not point within audio data A.

In this exemplary embodiment, editor 64 checks the content of the last or first frame of audio data to set and reset the flag. However, it is apparent that this flag can also be set and reset manually regardless of the state of audio data. This eliminates the need for a step to check the state of audio data. If the operator designating the demodulation sequence of audio data directly designates the flag, whether pieces of audio data to be decoded consecutively are previously one piece of audio data can be ensured, achieved the same effect as that of the second exemplary embodiment.

Third Exemplary Embodiment

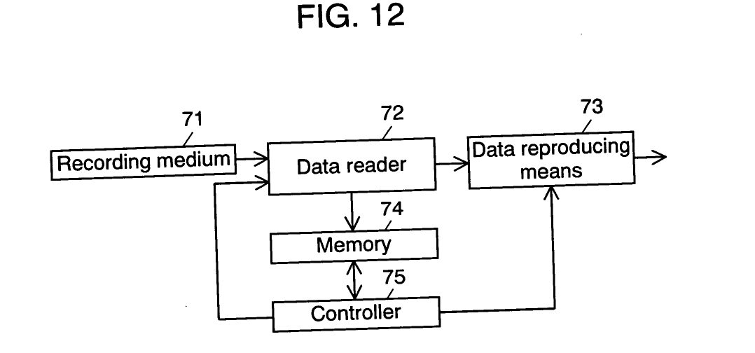

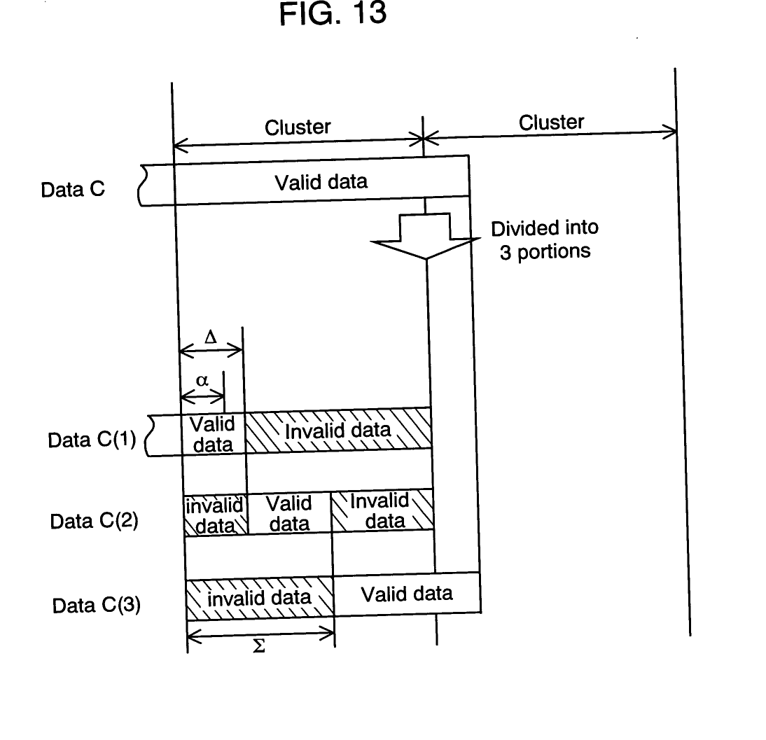

FIG. 11 shows a third exemplary embodiment of the present invention. As an example, the case of reproducing two pieces of compressed audio data consecutively is described. In the Figure, the same data as the last cluster of data A is added to the top cluster of data B when data A and data B are created by dividing one piece of audio data. Or, the same data same as the first cluster of data B is added to the last cluster of data A. The dividing point is between the end of valid data in the last cluster of data A and the top of valid data in the top data of data B. Accordingly, α portion of data from the beginning of the last cluster in data A and α portion of data from the beginning of the top cluster in data B match. The continuity/discontinuity can thus be determined by checking whether α portions of data in the Figure are matched. If they match, both pieces of data are determined to continue, and valid data in the last cluster of data A and valid data in the top cluster of data B are reproduced consecutively. If they do not match, both pieces of data are determined to discontinue, and thus the top portion of valid data in data B, such as top frame, is not reproduced. The aforementioned α portion can be freely set giving consideration to avoiding misjudgment of taking discontinuity as continuity. One example of making this method feasible is described next with reference to a block diagram in FIG. 12.

Compressed audio data and compressed audio data control information are recorded in recording medium 71. Data reader 72 stores aforementioned compressed audio data control information in memory 74. Controller 75 controls data reader 72 to read out applicable compressed audio data from recording medium 71 based on the compressed audio data control information. The compressed audio data which is read out is transferred to data reproducing means 73 for reproducing. At this point, for reproducing data A and data B in FIG. 11 consecutively, α portion of compressed audio data M from the top of the last cluster of data A and α portion of compressed audio data N from the top of the top cluster of data B are stored in memory 74 after reproducing data A but before reading out data B. Controller 75 compares compressed audio data M and compressed audio data N to determine whether they match. After completing comparison, data reader 72 reads out data B from recording medium 71, and transfers them to data reproducing means 73. Here, controller 75 designate data reproducing means 73whether to reproducing from the top of data B based on the comparison result.

If data A and data B are formed by dividing one piece of data in FIG. 11, data volume (β in FIG. 11) from the top of the last cluster to the dividing point in data A and data volume (γ in FIG. 11) from the top of the top cluster of data B to the dividing point match. Accordingly, the continuity/discontinuity can be determined with little processing just by comparing the data volumes β and γ in the Figure. Another example of making this method feasible is described next with reference to FIG. 12. A description of the same operations as that described in the previous example is omitted. In this example, controller 75 determines whether the data volume from the top of the last cluster of data A to the dividing point and the data volume from the top of the top cluster of data B to the dividing point match based on compressed audio data control information stored in memory 74 after reproducing data A but before reading out data B when data A and data B in FIG. 11 are to be reproduced consecutively. After completing determination, data reader 72 reads out data B from recording medium 71, and transfers it to data reproducing means 73. When data reproducing means 73 reproducing data B, controller 75 designates data reproducing means 73 whether to reproducing data B from the top part based on the determination result.

This allows to reproducing plural pieces of compressed audio data consecutively without generating abnormal noise.

Fourth Exemplary Embodiment

A fourth exemplary embodiment of the present invention is described next with reference to FIG. 13. Two cases of reproducing compressed audio data consecutively are described. FIG. 13 shows the case that data C is divided into three parts: Data C(1) to data C(3) in a cluster. The data volume from the top of the cluster to the top of data C(2) is Δ, and the data volume from the top of the cluster to the top of data C(3) is Σ. When data C(1) and data C(2) are reproduced sequentially, no misjudgment occurs by comparing both pieces of data (α in the Figure) because the end of data C(1) and the top of data C(2) are adjacent. However, when data C(1) and data C(3) are to be reproduced sequentially, misjudgment occurs by just checking comparison data (α in the Figure). Accordingly, the data volume from the top of the cluster to the data end C(1) (Δ in the Figure) and the data volume from the top of the cluster to the top of the data C(3) (Σ in the Figure) are compared, and the comparison data is judged only when data volumes match. The continuity/discontinuity is thus judged based on matching of data contents. If the data volume from the top of the cluster to the end of data C(1) (Δ in the Figure) and the data volume from the top of the cluster to the top of data C(3) (Σ in the Figure) do not match, these pieces of data are determined to discontinue. Since processing executed based on the determination of continuity and discontinuity is the same as that in the third exemplary embodiment, the description is omitted here. One example of making the above method feasible is described next with reference to FIG. 12. A description of the same operations as those already described for FIG. 12 is omitted. In this example, when data A and data B in FIG. 11 are consecutively reproduced, controller 75 determines whether the data volume from the top of the last cluster of data A to the dividing point and the data volume from the top of the top cluster of data B to the dividing point match based on the compressed audio data control information stored in memory 74. If they match, α portion of compressed audio data (M but not illustrated) from the top of the last cluster of data A and α portion of compressed audio data from the top of the top cluster of data B (N but not illustrated) are stored in memory 74 for comparing data contents. After comparison, data reader 72 reads out data B from recording medium 71, and transfers it to data reproducing means 73. If they do not match, data reader 72 immediately reads out data B from recording medium 71, and transfers it to data reproducing means 73. When data reproducing means 73 reproduces data B, controller 75 designates data reproducing means 73 whether to reproducing the top part of data B based on the determination result.

This allows the reproducing of data without generating abnormal noise even for reproducing any pieces of compressed audio data in plural pieces of compressed audio data which are divided into plural pieces within a cluster of recording medium 71.

### INDUSTRIAL APPLICABILITY

As described above, for audio data configured in units of frames with a header at the top and compressed in a way such that data corresponding to a specific frame is also present in a different frame, the present invention executes at least one processing (1) and (2) below at dividing the compressed audio data into two pieces of audio data, i.e., front and rear pieces, at a predetermined position.

(1) dividing the audio data into front and rear pieces, and a step to adding data of a predetermined number of bytes at the beginning of the rear audio data to the end of the front audio data.

(2) placing data of a predetermined number bytes from the end of the front audio data to the beginning of the rear audio data.

This prevents the generation of abnormal noise even in the case of data, typically MP3, in which the location of a frame and location of data used in that frame do not always match.

In addition, seamless reproducing is made feasible when two pieces of audio data, formed by dividing previously one piece of data, are reproduced consecutively.

1. A compressed audio data editing and reproducing method, said audio data being configured in units of frames with a header at a top of said frame and compressed in a way such that data corresponding to a specific frame is also present in a different frame, said editing method dividing said audio data into front and rear pieces of audio data at a predetermined position, and said editing method comprising at least one of the steps:
(a) dividing said audio data into front and rear pieces, and adding data of a predetermined number of bytes at the beginning of said rear piece of audio data to an end of said front piece of audio data; and
(b) dividing said audio data into the front and rear pieces, and adding data of a predetermined number of bytes from an end of said front piece of audio data to a front of the beginning of said rear piece of audio data.

2. The compressed audio data editing and reproducing method as defined in claim 1, said method applies at least one of:
(i) said data of a predetermined number of bytes at the beginning of said rear piece of audio data is not less than a top one frame of said rear piece of audio data; and
(ii) said data of a predetermined number of bytes from an end of said front piece of audio data is not less than a last one frame of said front piece of audio data.

3. The compressed audio data editing and reproducing method as defined in claim 1 further comprising the steps of:
reading a frame of said audio data sequentially; and
determining whether data for a specific frame exists in a top frame of said audio data,
wherein
if a determination result is “Not exist,” a step of reading a next frame and returning to said step of determination is executed; and
if a determination result is “Exist,” a step of reproducing the read frame is executed.

4. The compressed audio data editing and reproducing method as defined in claim 1, wherein when said rear piece of audio data following said front piece of audio data, the method comprises the steps of:
comparing data of a predetermined number bytes from an end of said front piece of audio data and data of a predetermined number of bytes at the beginning of said rear piece of audio data; and
determining whether to reproduce from the beginning of said rear piece of audio data based on a comparison result of said comparing step.

5. The compressed audio data editing and reproducing method as defined in claim 1, wherein said audio data is recorded in a recording medium using a cluster as a writing and reading unit.

6. The compressed audio data editing and reproducing method as defined in claim 5, said reproducing method further comprising the step of determining whether data needed for reproducing a specific frame of said audio data exists in a cluster before a top cluster of said audio data, wherein if the data does “Not exist”, data in said specific frame is not reproduced.

7. The compressed audio data editing and reproducing method as defined in claim 5, wherein when dividing said audio data, said editing method comprises the steps of:
copying a last cluster of the front piece of audio data to create a cluster having an identical content; and
making said cluster as a first cluster of said rear piece of audio data.

8. The compressed audio data editing and reproducing method as defined in claim 5, said editing method further comprising a step of determining whether a dividing point of said audio data matches a boundary of said cluster, wherein if said dividing point and said boundary match, said audio data is not divided at that point.

9. The compressed audio data editing and reproducing method as defined in claim 5, said editing method further comprising the steps of:
determining whether a dividing point of said audio data matches a boundary of said cluster; and
adding a top one cluster of the rear piece of audio data to an end of the front piece of audio data when said dividing point and said boundary match.

10. The compressed audio data editing and reproducing method as defined in claim 5, said editing method further comprising:
determining whether a dividing point of said audio data matches a boundary of said cluster; and
adding a last cluster of the front piece of audio data to immediately before the beginning of the rear piece of audio data as invalid data when said dividing point and said boundary match.

11. The compressed audio data editing and reproducing method as defined in one of claims 9 and 10, wherein when reproducing said rear piece of audio data following said front piece of audio data, said method comprising the steps of:
comparing the last one cluster of said front piece of audio data and a top one cluster of said rear audio data; and
determining whether to reproduce from the top of the rear piece of audio data based on a comparison result said comparing step.

12. A compressed audio data editing and reproducing method comprising the step of:
using a memory for storing audio data and a flag related to said audio data, said audio data being configured in units of frames with a header at the top and compressed in a way such that data corresponding to a specific frame is also present in a different frame, a demodulator for demodulating an audio signal based on said audio data and said flag, and an editor for dividing and connecting said audio data and setting and resetting said flag based on a state of divided audio data.

13. The compressed audio data editing and reproducing method as defined in claim 12, wherein
said flag indicates that at least a part of data corresponding to a top frame of corresponding audio data is not included in said audio data; and
said demodulator:
when said flag is reset, decodes from the top frame of said audio data, and
when said flag is set, decodes only a frame whose corresponding data exists in said audio data.

14. The compressed audio data editing and reproducing method as defined in claim 12, wherein said audio data is recorded in a recording medium using a cluster as a writing and reading unit.

15. The compressed audio data editing and reproducing method as defined in claim 12, wherein said editor comprises at least one of the following means:
(i) adding data of a predetermined number of bytes at the beginning of second audio data to an end of said first audio data and
(ii) adding data of a predetermined number of bytes from an end of first audio data to a front of the beginning of said second audio data, when said audio data is divided into said first and second audio data.

16. The compressed audio data editing and reproducing method as defined in claim 12, wherein
said flag indicates whether to input and decode audio data related to said flag consecutively after another specific audio data previously given to said demodulator; and
said demodulator:
when said flag is reset, inputs and decodes audio data related to said flag consecutively after said another audio data previously given to said demodulator, and
when said flag is set, decodes only a frame whose corresponding data exists in said audio data wherein said audio data is consecutively given to said demodulator after said another audio data previously given to said demodulator.

17. The compressed audio data editing and reproducing method as defined in claim 15, wherein
said editor comprises a comparator for comparing a last portion of said first audio data and a first portion of said second audio data before continuous reproducing of the first and second audio data is determined and the first and second of audio data are provided to said demodulator,
a flag is set based on a comparison result of said comparing, and
said demodulator determines whether to decode from the top frame of said second audio data based on a state of said flag, when demodulating said second audio data following said first audio data.

18. The compressed audio data editing and reproducing method as defined in claim 12, wherein said editor sets a flag related to a second audio data when audio data is divided into two pieces in order of first and second audio data.

19. The compressed audio data editing and reproducing method as defined in claim 12, wherein said editor sets and resets said flag regardless of said state of said divided audio data.

20. A compressed audio data editing and reproducing method comprising the steps of:
editing said compressed audio data in a way such that a last cluster of a front portion of said compressed audio data and a top cluster of a rear portion of said compressed audio data are duplication when said compressed audio data, in which data corresponding to a header exists before said header of a frame, is divided into units of frames;
comparing predetermined data at the beginning of the last cluster of said compressed audio data to be reproduced first and predetermined data at the beginning of the top cluster of said compressed audio data to be reproduced second when two pieces of said compressed audio data are consecutively reproduced; and
determining whether to reproduce a top part of said compressed audio data to be reproduced second based on a comparison result of said comparing step.

21. A compressed audio data editing and reproducing method comprising:
editing said compressed audio data in a way such that a last cluster of front portion of said compressed audio data and a top cluster of a rear portion of said compressed audio data are duplication when said compressed audio data, in which data corresponding to a header exists before said header of a frame, is divided into units of frames;
comparing data volume from the beginning of the last cluster to a data end of said compressed audio data to be reproduced first and data volume from the beginning of the top cluster to a data end of said compressed audio data to be reproduced second when two pieces of said compressed audio data are consecutively reproducing; and
determining whether to reproduce a top part of said compressed audio data to be reproduced second based on a comparison result of said comparing step.

22. A compressed audio data editing and reproducing method comprising:
editing said compressed audio data in a way such that a last cluster of a front portion of said compressed audio data and a top cluster of a rear portion of said compressed audio data are duplication when said compressed audio data, in which data corresponding to a header exists before said header of a frame, is divided into units of frames;
comparing predetermined data at the beginning of the last cluster of said compressed audio data to be reproduced first and predetermined data at the beginning of the top cluster of said compressed audio data to be reproduced second;
comparing data volume from the beginning of the last cluster to a data end of said compressed audio data to be reproduced first and data volume from the beginning of the top cluster to a data end of said compressed audio data to be reproduced second when two pieces of said compressed audio data are consecutively reproduced; and
determining whether to reproducing a top part of said compressed audio data to be reproduced second based on a comparison result of said comparing steps.
